(19) United States
(12) Patent Application Publication
(10) Pub. No.: US 2021/0023518 A1
(43) Pub. Date: Jan. 28, 2021

(54) AUTOMATIC MACHINE FOR MIXING AND DISPENSING LIQUID DETERGENTS REMOTELY CONTROLLED

(71) Applicant: Oscar Ignacio LEON CHACIN, Caracas (VE)

(72) Inventor: Oscar Ignacio LEON CHACIN, Caracas (VE)

(21) Appl. No.: 16/520,288

(22) Filed: Jul. 23, 2019

(51) Int. Cl. B01F 13/10; B01F 15/00; B01F 7/24; B01F 15/02; B67C 3/22; B01F 3/08; B67C 3/00

(52) U.S. Cl. CPC B01F 13/1063; B01F 2215/0431; B01F 7/24; B01F 15/00253; B01F 15/0244; B01F 13/1069; B67C 3/22; B01F 3/0861; B67C 3/007; B01F 15/0291; B01F 3/0853; B01F 3/088; B01F 15/00155; B01F 15/00344; B01F 2215/0077; B01F 2003/0896; B01F 2215/008; B01F 15/00194

(57) ABSTRACT

An automated machine is provided for mixing and dispensing liquid detergents remotely controlled by a control software connected to a server which updates product databases, which is executed, together with other software for dispensing and delivering liquid content and surfactant detergent with anionic and cationic tensio-active chemical compounds as the basis of its selected formulation of Genapol, sodium phenyl sulfonate and the sodium lauryl sulfonate with preservatives such as formaldehyde and bactericides such as glutaraldehyde in a mixture of concentrated detergent with water in a proportion between 30% and 40%; where said machine is manipulated with a touch screen that drives two types of injectors that send product, to make the liquid mixture, to a static mixer or to a dynamic mixer and said machine conducts said mixed liquid to a tank of finished product to be dispensed by a filling spout placed on the front of a container-shaped casing.

### INDUSTRIAL APPLICATION AND FIELD OF THE INVENTION

The present invention is related to the field of engineering, particularly in the area of mechanical, electrical and electronic (mechatronic) engineering, by providing an automated machine for mixing and dispensing liquid detergents remotely controlled by a control software connected to a server which updates product databases, which is executed, together with other software for dispensing and delivering liquid content and surfactant detergent with anionic and cationic tensio-active chemical compounds as the basis of its selected formulation of Genapol, sodium phenyl sulfonate and the sodium lauryl sulfonate with preservatives such as formaldehyde and bactericides such as glutaraldehyde in a mixture of concentrated detergent with water in a proportion between 30% and 40%; where said machine is manipulated with a touch screen that drives two types of injectors that send product, to make the liquid mixture, to a static mixer or to a dynamic mixer and said machine conducts said mixed liquid to a tank of finished product to be dispensed by a filling spout placed on the front of a container-shaped casing.

### BACKGROUND OF THE INVENTION

In the state of the art is known the patent application No. WO2017/153803 published on Sep. 14, 2017 by the same inventor of this application, which summary is the following “dispensing devices for viscose and liquid chemicals with an integrated control system, for domestic, institutional and industrial use. The purpose of the invention is to offer the user environmentally friendly bulk products that meet their needs, avoiding the manufacture of new plastic containers by reusing the existing containers. The dispensing device is easy to use and works with a delivery system that can accept any container according to the volumes dispensed by the device”. This new invention improves the execution of the combination of detergents and liquids; expressing what types of inputs can be executed by the machine; also, the new invention details the way of execution, not disclosed in the background and supplemented with software in a new configuration of components.

Also known is the patent application No. U.S. Pat. No. 9,550,662 of the inventor Laurie J. Brown granted on Jan. 24, 2017, which summary describes “a method and apparatus for selling a fluid in a container includes placing a machine-readable indication in the container that identifies the base fluid. The container can be filled and then distributed or distributed before being filled through several distribution channels to consumers. When a consumer wants to fill or refill the container, the consumer places the container next to a reader that interprets the indications to identify the base fluid that must be dispensed. Then, a dispenser fills the container through a mobile filling probe that rises as the liquid increases inside the container. In some embodiments, and prior to filling, the dispensing apparatus may also consult the consumer about the options offered at dispensing to dispense more diverse optional ingredients, including flavors, colors, nutritional supplements or other additives together with the base product. In additional embodiments, the dispenser may also print discount tickets or coupons that may discount the purchase of the fluid in a container or other promotional merchandise. Machine-readable signs may include affiliate codes that allow accrediting or compensating several affiliates in connection with filling the container.” For its part, the new invention can fill any container overcoming the limitations of the background that requires the reading of barcodes of the label to be able to dispense the detergent, the invention does not require this identification facilitating the user to obtain the product without limitations.

Also known is US Patent No. US 2015225224 A1, inventor: TILTON DONALD E. and others of Feb. 5, 2010, which summary is as follows: “Methods and apparatus describing a beverage vending machine for convenience and operation. An integrated computer interface allows consumers to create their own drinks or choose from a beverage menu. The drinks are dispensed in a reusable container. The drinks can be made of hot water, cold water or carbonated water that is mixed with various flavors of syrup, sweeteners and nutritional supplements. The identification can be presented and the computer recognizes the consumer and takes out the consumer's account to determine the available funds and the selections and mixes of previous beverages. The machine can incorporate an automatic cleaning cycle for both the valves and the dispensing area.”

US Patent No. US 2015230653 A1, inventor CHENG BI, of Feb. 19, 2014, whose summary is as follows: “Automatic beverage dispensing unit (“ABU”) capable of automatically preparing a beverage according to an order through a communications network. In one aspect, ABU includes a communication device, a beverage preparation device and a beverage dispenser, in which the communication device communicates with a user through a wireless communication network. The beverage preparation device, in one example, includes a pod mixer and a liquid container, wherein the pod mixer is configured to select a first pod of multiple pods according to the order of a user. The liquid container prepares a liquid substance such as water based on the selected sheath. The beverage distributor mixes the capsule and the liquid substance to produce a beverage that is stored in a temperature-controlled dispensing compartment for collection.”

US Patent No. US 2015102049 A1, inventor FLEISHMAN BRETT of Oct. 5, 2011, whose summary is as follows: “A vending machine that includes a warehouse to hold bulk goods and multiple reconfigurable devices of the distribution path to release the goods to a buyer in an entertaining way.”

Patent No. WO 03038770 A2 equivalent to US No. 20030079612 A1, inventor ALFREDO CON, dated Oct. 29, 2001, which summary is as follows: “An apparatus for preparing and distributing beverages based on selections introduced by consumers is provided, including one or more sources of roasted coffee beans; One or more sources of teas; One or more sources of cocoa; At least one mill for preparing ground coffee of said roasted coffee beans; One or more sources of flavoring ingredients; A source of water; One or more sources of fresh dairy products; And a mechanism to prepare the drink. A method for preparing a beverage according to selections introduced by a consumer is also provided, including receiving selections of beverages introduced by a consumer; Collect the payment for the drink based on the selections of drinks introduced; Retrieve pre-established standards for the proper preparation of the beverage based on beverage selections; Show the beverage preparation process and the freshness of the ingredients used to prepare the beverage; Prepare the drink according to the pre-established norms; Supervise the preparation of the beverage for compliance with pre-established standards; And provide the drink to the consumer.”

US Patent No. US 2015013545 A1, inventors EGLI et al., Dated Mar. 9, 2013, which summary is as follows: “A beverage vending machine has a housing, in which means are accommodated for preparing and dispensing a beverage of Coffee prepared using freshly ground coffee. The flexible configuration is made possible because the means have a modular construction and comprise at least one base module for preparing the coffee beverage and a separate outlet module for dispensing the coffee beverage which are in fluid connection with each other by means of one or more fluid interfaces.”

From the foregoing, all patents are for dispensing hot beverages and bulk food products. The electro-mechanical elements that implement these patents, although it is true that they are electronically controlled, their components are not comparable with that of the machine proposed in the present invention. Each patent cited has its own components adapted to a specific function, with electronic cards designed specifically to dispense the different products. None of the patents cited as background have remote information sent to an information center to monitor the levels of filling of the different tanks and consequently proceed to replenish them. An important function of the present invention is that it works with concentrated detergent liquids which reduces in weight and cost the transport of at least 30% for the replenishment of the concentrated liquid detergent to the machine. This feature is unique in the proposed invention.

As an important conclusion is to note that all patents cited are from different owners and among them can have much greater affinity or relationship between its components and control cards used for the preparation and conditioning of temperatures to supply hot beverages and yet they obtained patents coexisting in the market with exclusivity without any conflict.

Publications of mixing or dispensing machines for household use of liquid detergents in commercial locations have not been found, that could be comparable to the mixing and dispensing machine proposed in this invention.

From the previous material investigated we can conclude that this does not constitute an antecedent of the state of the relevant technique that may interfere with the proposed novel concept of the present invention, there is novelty in the invention because there is a solution to a technical problem and a demand of domestic users, it is not speculative because the prototype has been satisfactorily developed, it is reproducible industrially and in series; Up to the present date it has been a motivation of potential clients that augur commercial success, to put into service these machines in different commercial and residential areas of any country in the world.

### DESCRIPTION OF THE INVENTION

The automatic machine for mixing and dispensing liquid detergents remotely controlled delivers to the user the products stored in the tank of the machine to fill reusable containers, favoring the conservation of the environment.

The machine was designed to dispense products in the largest variety of reusable containers and in different materials. This machine has a storage tank which is connected to a filling mechanism, consisting of a peristaltic pump, hoses and pipes, a filling spout and a weighing scale controlled by an automation software developed for this purpose.

The machine has an automation software, a management software and an interactive screen that allows to visualize and record on this screen the actions executed by the equipment.

The Automation Software is responsible for controlling the automatic dispensing of the product requested by the user, performing the actions described below:

Allows the reading of barcodes.

Validate the presence of the container to be filled with product.

Establishes connection to the charge cell.

Controls the operation of the peristaltic pump (start/back/stop).

Validate the revolutions per minute with a pulse counter sensor.

The management software allows monitoring the commercial activities of the owner of one or several machines, performing the actions described below:

It allows to carry in real time the inventory control of the product in tank with respect to the liters sold by the equipment.

Exports the selected data to a spreadsheet.

Establish remote connection via internet.

Additionally, it allows monitoring the conditions of the electronic equipment by the technical support team.

A computer with a touch screen allows the user to interact with the computer, by displaying messages; in turn establishes the connection via wifi to a server and to the web (internet).

As a way to illustrate the present invention, a brief description of the figures is given by way of explanatory example of the embodiment in a preferred form of the invention as follows:

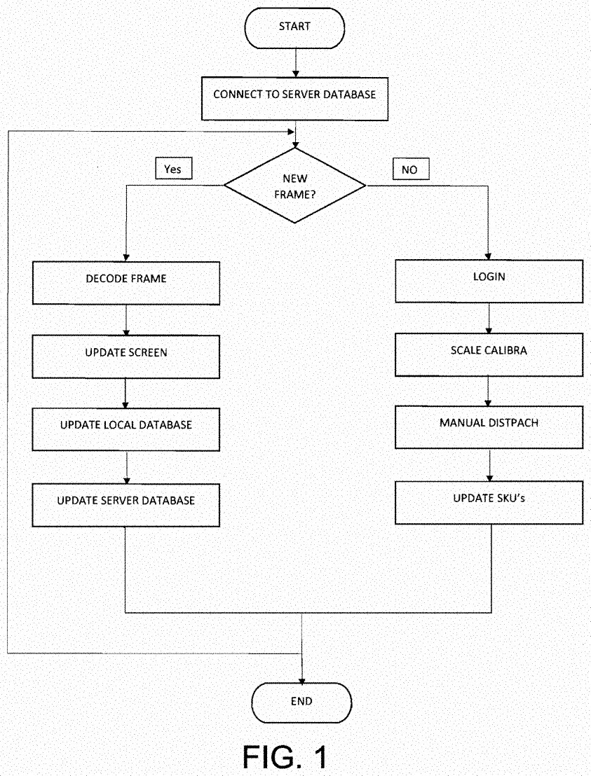

FIG. 1: Shows a process flow diagram of the machine control software for mixing and dispensing liquid detergent.

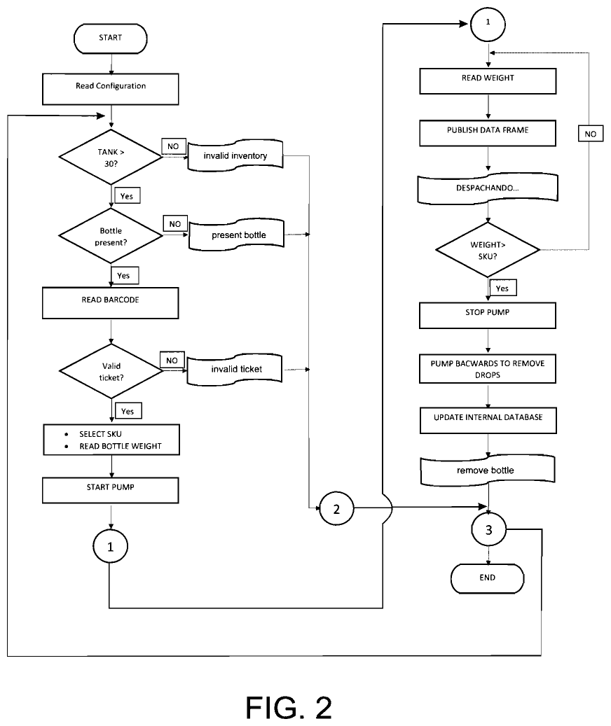

FIG. 2: It shows a process flow diagram of the dispensing software that is executed from the interface of the machine to communicate with the user.

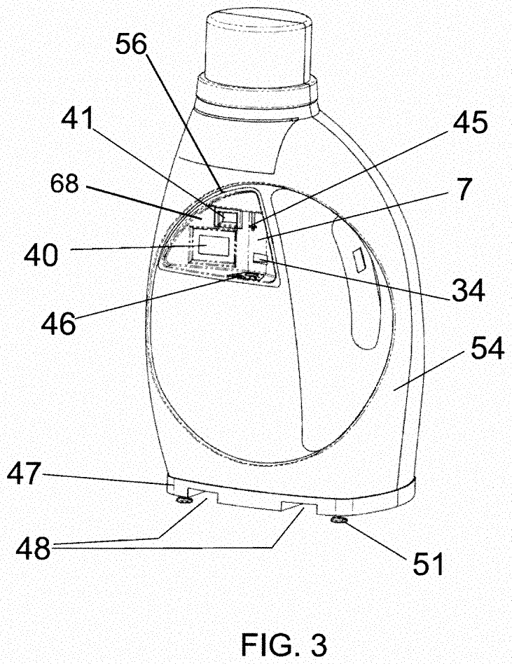

FIG. 3: It shows the casing in the form of a container for the machine to mix and dispense liquid detergent with its external components of use.

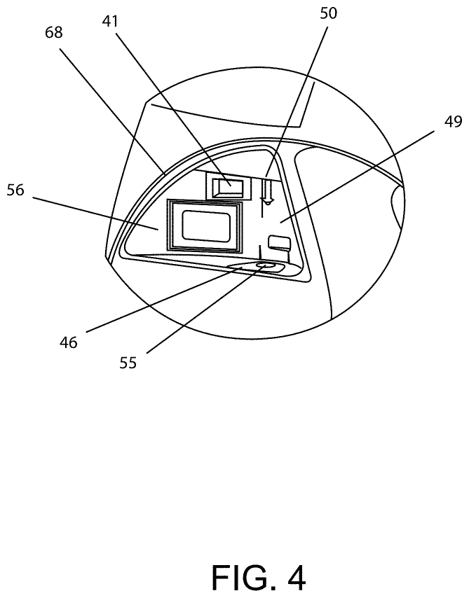

FIG. 4: It shows the dispensing frame with the operation indicators of the machine, the Led indicator of presence of container and the permanent light Led.

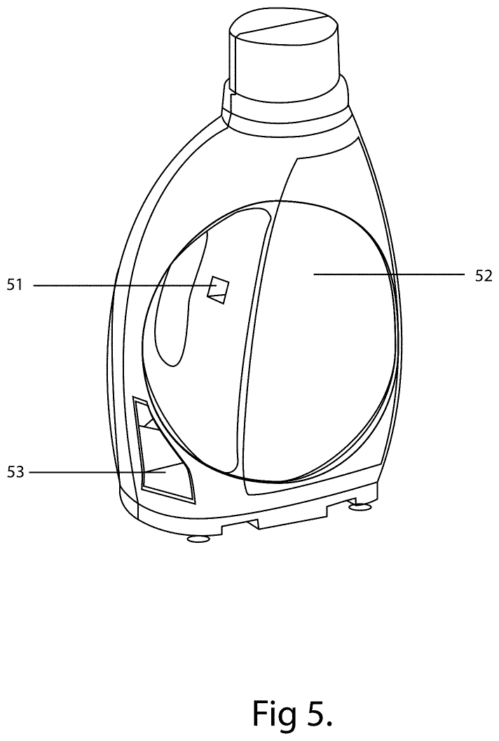

FIG. 5: It shows the rear part of the carcass with a container shape with its filling gate, rear gate and hydraulic system inspection hatch.

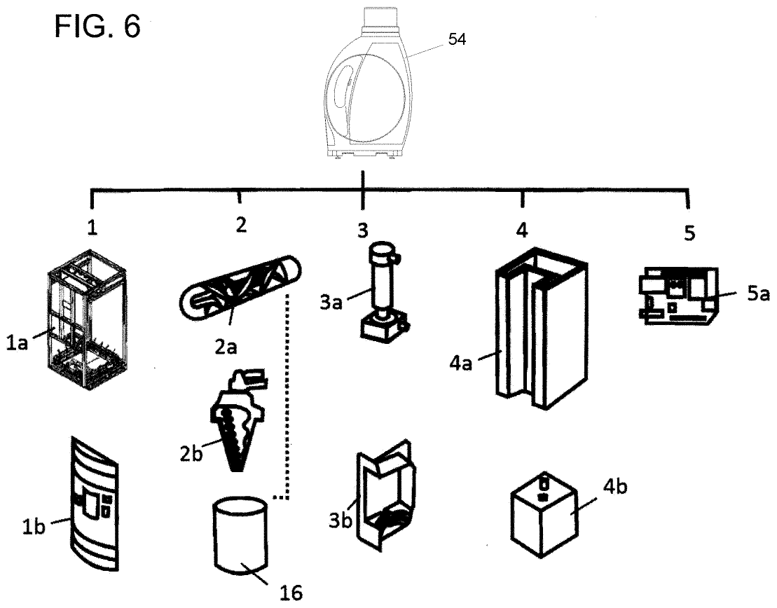

FIG. 6: It shows a diagram of the internal components of a machine to mix and dispense liquid detergent with all its electromechanical components that comprises it.

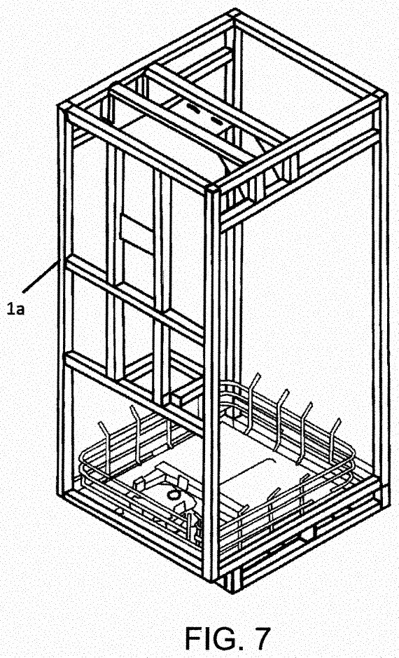

FIG. 7: It shows a proposal of internal structure of the machine to mix and dispense liquid detergent.

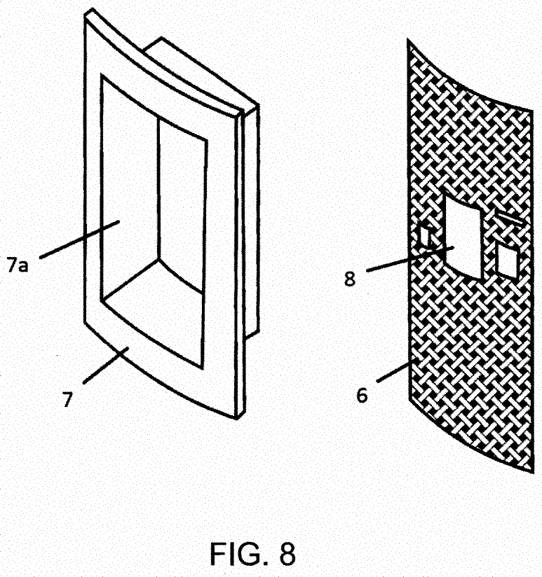

FIG. 8: It is a convex-shaped cover provided with a central cavity for the insertion of a window frame to insert the unit of bases that fit the containers to be filled that covers the internal structure and is under the container-shaped carcass.

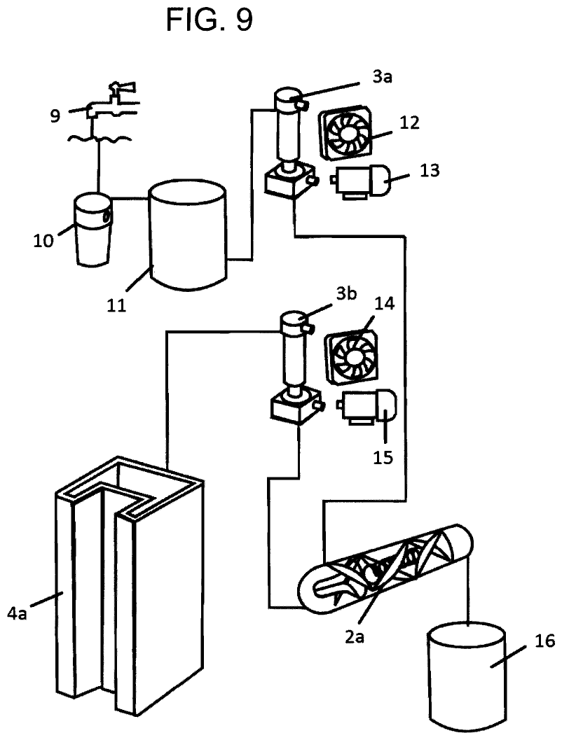

FIG. 9: It is a scheme of a static mixer with all its electromechanical elements that compose it.

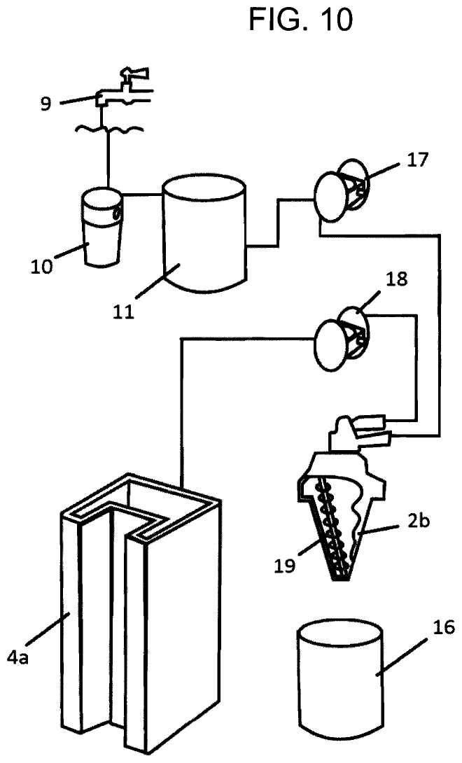

FIG. 10: It is a scheme of a dynamic mixer with all its electromechanical elements that compose it.

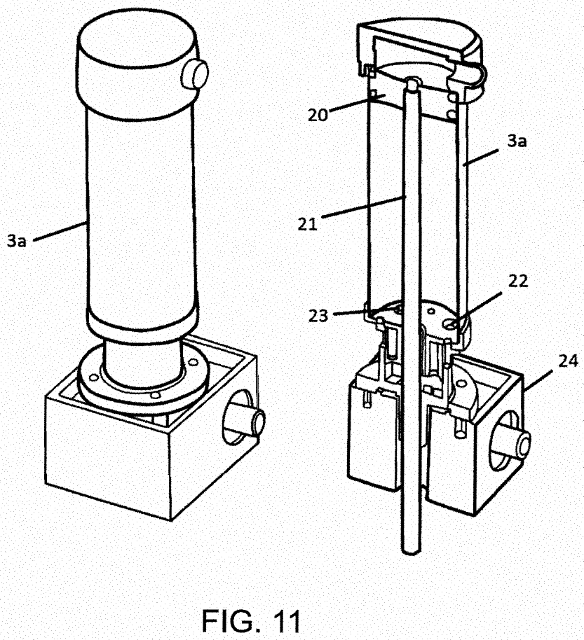

FIG. 11: It shows a perspective of a liquid detergent injector and a longitudinal cut to visualize the internal elements of the component.

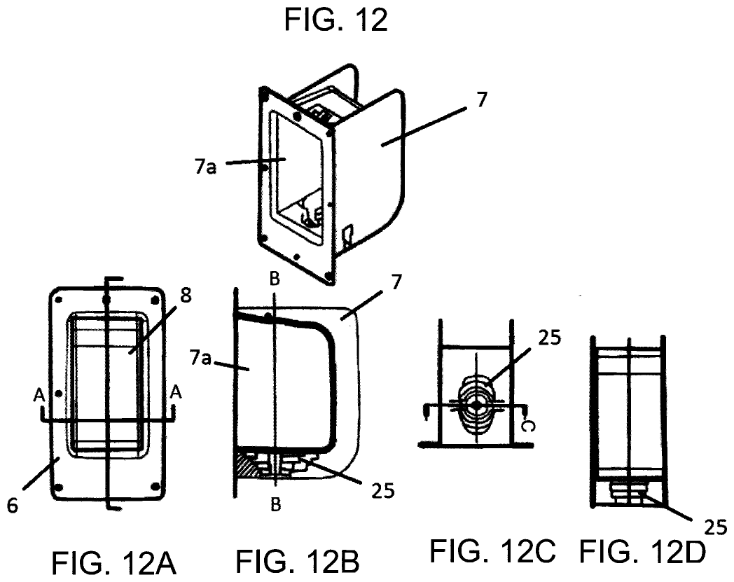

FIG. 12: It shows an adaptable base to the different variable bases of the selected containers that is located under the filling spout.

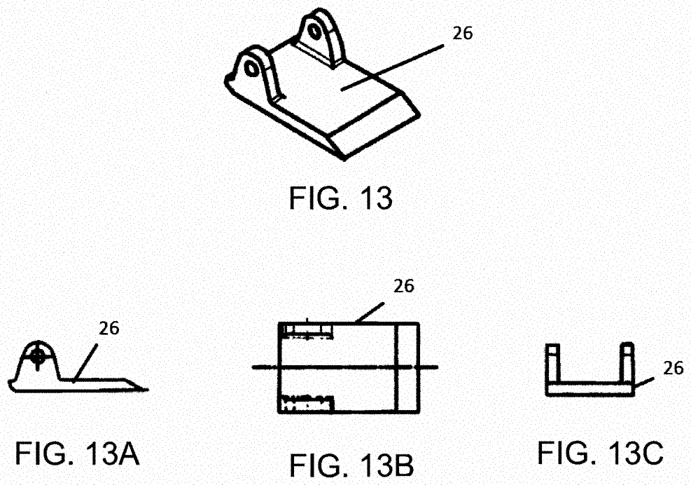

FIG. 13: It is a perspective figure of another basis for the selected containers.

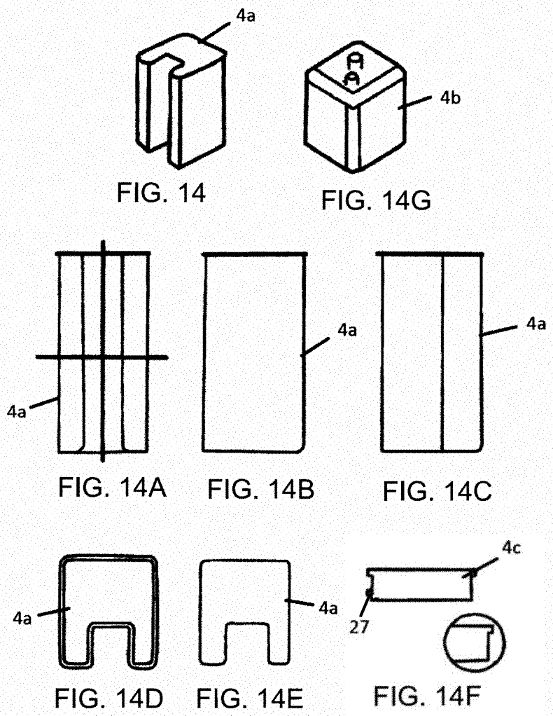

FIG. 14: There are 2 figures in perspective, one from the main tank and another from the overflow tank that are liquid detergent containers. This figure provides another group of flat views that detail its internal and external conformation.

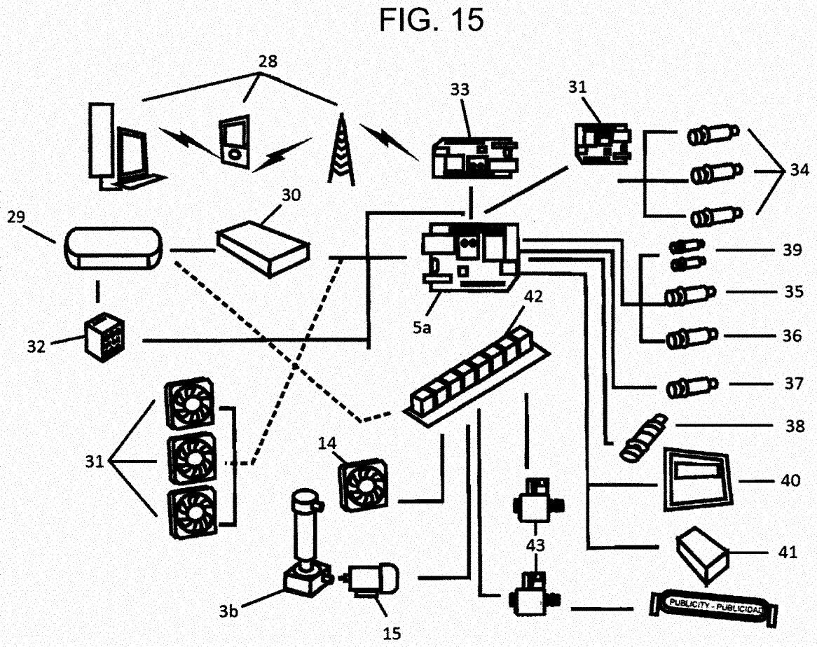

FIG. 15: It is a block diagram of the electromechanical system of internal and external installation for the operation and control of the liquid detergent to be dispensed.

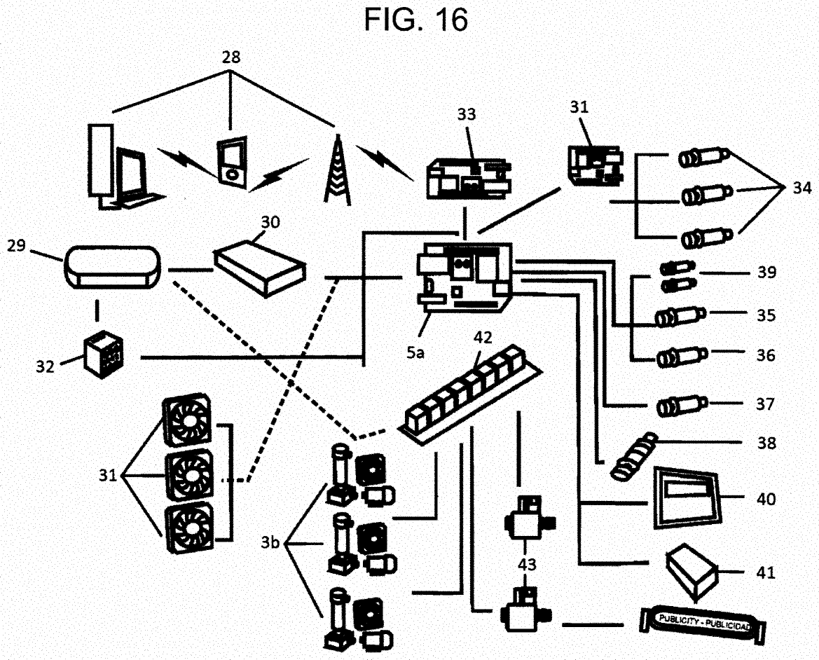

FIG. 16: It is a block diagram of an electromechanical unit for internal and external installation for the operation and control of the liquid detergent to be dispensed with a static mixer.

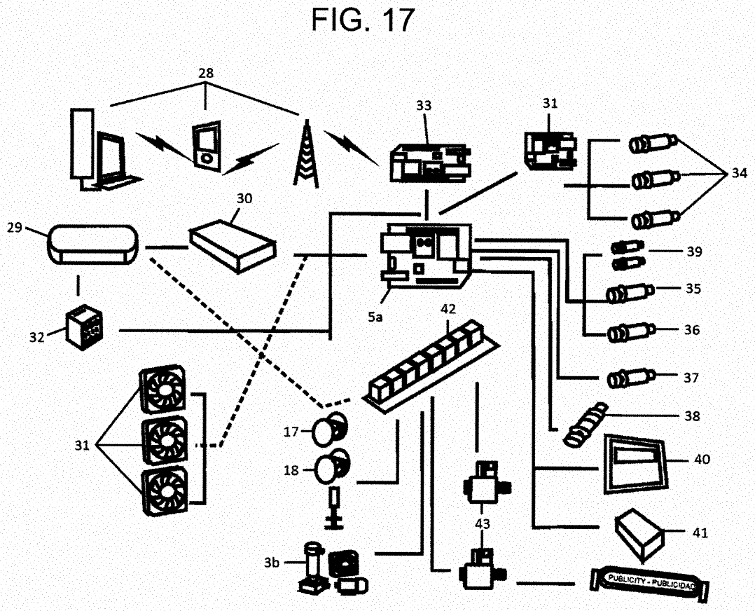

FIG. 17: It is a block diagram of the same electromechanical unit of internal and external installation for the operation and control of the liquid detergent to be dispensed with a dynamic mixer.

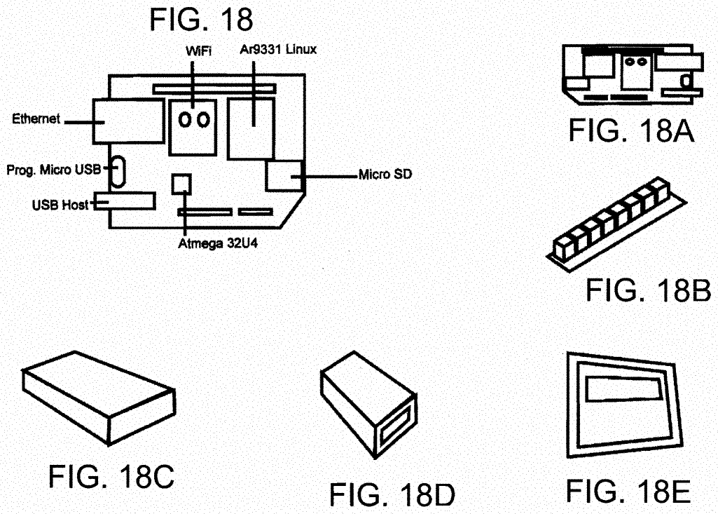

FIG. 18: It is a block diagram of another electromechanical unit of internal and external installation for the operation and control of the liquid detergent to be dispensed, provided with a main control card; of a connection card, and other integrated elements for its operation.

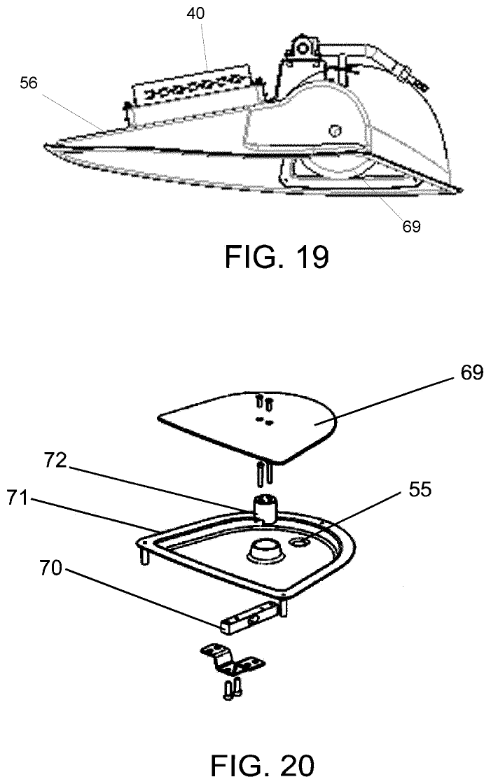

FIG. 19: Shows a top view of the dispensing frame with its components.

FIG. 20: Shows the mechanism of the scale that calculates the weight of the material dispensed in the filling container.

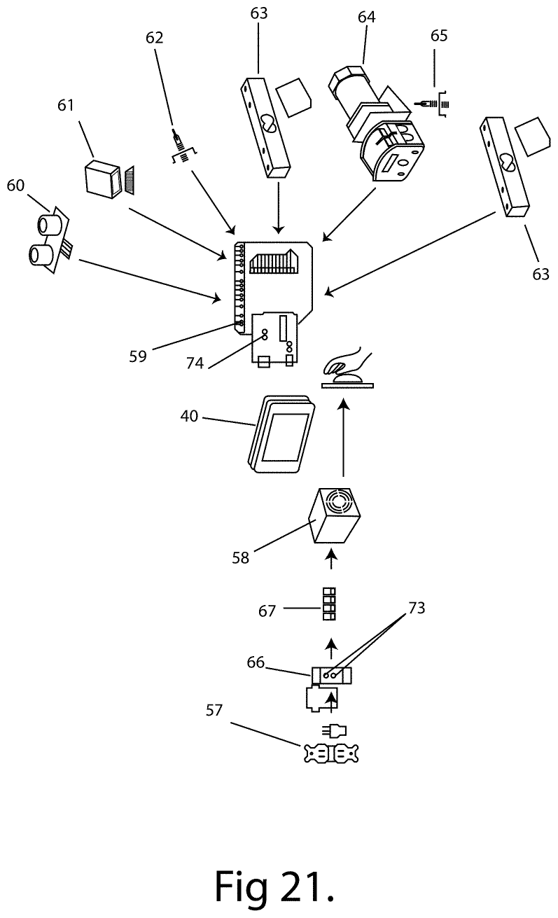

FIG. 21: It is a scheme that shows the components of the device executed by the software.

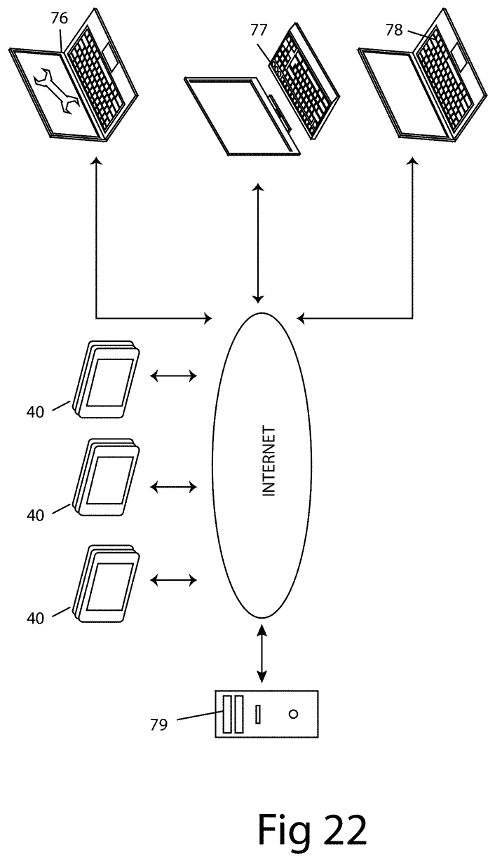

FIG. 22: Shows an interconnection diagram and operation of a device set.

### DETAILED DESCRIPTION OF THE INVENTION

According to FIG. 1, the machine is remotely controlled or on site where it is located by connection to a server that updates the databases of content of liquid and detergent, weight of the mixture and calibration of quantity to be delivered when executing two injectors (3a) and (3b) driven by an axis (21) of longitudinal displacement of suction of the filtered water of a tank of filtered water (11) and of suction of concentrated liquid of an overflow tank (4a), which control software executes two connected solenoid valves that take liquid to from upper cylinder (20) and send it to a static mixer (2a) or a dynamic mixer (2b), where said solenoid valves are formed by a fluid filling solenoid valve (22) and another solenoid valve of fluid return (23) which conduct the mixed liquid to a tank of finished product (16) located in the lower part of the dispenser.

The main structure is composed of molded pieces of polyester reinforced fiberglass (prefabricated monoblock shells), with also structural spaces that internally support the basic components such as: the product storage tank, mechanism of peak filling, scale, pump peristaltic with control system and touch screen; wherein said structure in the form of a container (54) or another external form, is a housing composed of a front part of the housing and a rear part of the housing joined by bolts and manufactured by molded pieces of polyester reinforced in fiberglass (prefabricated monoblock shells). Where the structure houses in its front casing an interactive module (68) inside the dispensing frame (56), which is a preformed piece that houses the elements that serve as fixing support for the computer, the scanner, the container presence sensor, container carrier with a load cell and filling peak.

The dispensing frame (56) is made of polyester reinforced with glass fiber, has a filling peak with vertical displacement to adapt to the different sizes of containers, where said filling peak is made of stainless steel and has an anti-drip mechanism.

According to FIG. 2, the machine is executed by the user by means of a touch screen (40) with a dispensing software that drives the machine to mix and dispense liquid detergent, according to the presentation of an empty container or bottle to fill it with detergent mixed with water. Said dispensing software requires the user to present the empty bottle, operate the touch screen, calculate the weight of the bottle and the amount of mixture that it admits and finally dispense the mixed detergent according to the amount of detergents and water in proportions chosen between 30% and 40% of surfactants with tensio-active anionic and cationic chemical compounds as base of their formulation selected from Genapol, sodium phenyl sulfonate and sodium lauryl sulfonate; and preservatives such as formaldehyde and bactericides such as gluteraldehyde.

FIG. 3 shows the housing in the form of a container (54) of the machine for mixing and dispensing liquid detergent with its external components, which is composed of a touch screen (40) with an interface for executing the dispensing software that performs a process according to the flow chart of FIG. 2; the scanner (41) that verifies the reading of a barcode associated with the amount of detergent mixture to be dispensed; a filling spout (45) located at the top of the container detector (34); a spill grid (46) with a scale (55) located in the lower part of the window (7) of the receiver of empty bottles.

It is noted that the container-shaped housing (54) has a reinforced base (47) with transport guides (48) and legs (51) and the interior of the window (7) of the bottle receiver is the presence of a LED indicator of container (49) and a permanent led light (50) to visualize the dispensation.

FIG. 4 shows that the dispensing frame (56) is made of polyester reinforced with glass fiber, it has a filling peak with vertical displacement to adapt to the different sizes of containers, the peak is made of stainless steel and consists of an anti-drip mechanism.

FIG. 5 shows the rear part of the container-shaped casing with its filling gate (51), rear gate (52) for access to the structure (1a) and the hydraulic inspection gate (53) in the bottom.

FIG. 6 is a perspective of the internal part of the machine for mixing and dispensing of liquid detergent with a sequential diagram of assembly with all its electro-mechanical elements that integrate it; said detergents are surfactants with tense active anionic and cationic chemical compounds as the basis of their formulation, such as Genapol, sodium phenyl sulfonate and sodium lauryl sulfonate. In the same way these detergents contain preservatives such as formaldehyde and bactericides such as glutaraldehyde, all these substances are soluble in water, but none is for human consumption, with these formulations the concentrated detergent is prepared to be mixed with water in a proportion between 30% and 40%; the sequence (1) comprises the metal structure (1a) which can vary according to the available physical spaces, and with adjustable load capacity according to the size and weight of the main tank (4a); said structure is assembled with the convex metal door (1b), it is made with high impact material that allows to protect the internal parts of the machine; the sequence (2) is a static mixer (2a) and a dynamic mixer (2b) optionally assembled to finally deposit the liquid detergent to the tank (2c) ready to be expended; the sequence (3) is an injector (6a) which can be hydromantic or pneumatic; said injector is based on the adaptation of a piston that moves vertically inside a cylinder of predetermined volume. The stroke of the piston determines the amount of liquid detergent dispensed. During the descending journey, the same, sucks the amount of predetermined product of the tank, while in the ascendant it dispatches it; the liquid detergent, from where the fluid can go to the dispenser in the window (7) or continue to the sequence (4) to the tank (4a) and from this to another overflow tank (4b); finally the sequence (5) shows the electronic control system (5a) which is connected internally to drive the electromechanical elements and externally with electronic components of remote connection.

FIG. 7 is a perspective of the machine with the structure (1a), comprised of a set of vertical and transverse profiles to internally form several three-dimensional supports that receive the different assembly components enunciated in the sequences (1 to 5) of the FIG. 1. Outside the main structure is the tank (4a) with its cover (4d) and its connections (27), one for filling with safety coupling, another connection for liquid level control, and a third connection for suction of the tank to the injection cylinder, to be inserted in the main structure (1a).

FIG. 8 shows two perspectives illustrating the front cover of the internal structure, formed by a convex cover (1b) provided with a central rectangular opening (8), for receiving a window frame (7) which in turn has a central window (7a), suitable for placing adjustable bases for the containers of the liquid to be dispensed. Said convex cover (1b) is made of a high impact material that allows to protect the internal parts of the machine.

FIG. 9 represents the schematic system of Static Mixing, which consists of the connection of water with the concentrated detergent through a pumping process that forces the concentrated liquid detergent and water, to circulate through shared chambers until obtaining a homogenous mixture, it is designed to handle variable proportions of liquid detergent; The mixing process occurs in three stages:

a) A first pump (3a) is driven by a vacuum (12) with a motor (13), which sucks filtered water from a tank (11) which is fed through the external tap (9) and the filter (10), in a certain proportion.
b) In parallel, a second pump (3b) sucks, by means of a vacuum (14) with a motor (15), the concentrated liquid detergent from the main tank (4a) in a predetermined proportion.
c) Both pumps (3a) and (3b) feed the static mixer (2a) with a constant flow and pressure to thereby achieve a homogeneous mixture, which is deposited in a tank (16) of prepared liquid detergent, from where it is subsequently sucked by the injection system to be dispensed into the selected container.

FIG. 10 is the schematic system of another variant of the invention, with a dynamic mixer (2b), which mixes the water with the concentrated liquid detergent through a mixing process using blades attached to an axle that performs a rotary movement to homogenize the mixture, it is designed to handle variable proportions of water and concentrated detergent, and said mixing process occurs in three stages:
a) A diaphragm pump (17) sucks filtered water from a tank (11) in a certain proportion.
b) In parallel, a second diaphragm pump (18) sucks the concentrated liquid detergent from the main tank (4a) in a predetermined proportion.
c) Both diaphragm pumps (17) and (18) feed the dynamic mixer (2b), where the filtered water and the concentrated liquid detergent are connected through a stirring screw (19), producing a homogeneous mixture, which is deposited in a prepared liquid detergent tank (16), from where it is sucked by an injection system to be dispensed into a container.

FIG. 11 is a perspective view of the injector (6a) of the liquid detergent prepared with a longitudinal cut to visualize the internal elements of the component; it contains an upper cylinder (20), driven by an axis (21), longitudinal displacement, which allows the laminar flow of the liquids avoiding foam formation and occlusion thereof, on the other hand, has two electrovalves (24) that control the entry and exit of the product, with a filling passage (22) and another passage for the return (23) of the prepared liquid detergent, from the cylinder to the static (2a) or dynamic (2b) mixer (shown in FIG. 4 or 5 respectively).

FIG. 12 is a perspective of the window (7) that fits into the opening (8) of the cover (1b) to allow through the opening (7a) (shown in FIG. 8) to place the optional bases (25) of adaptation to different containers as shown in the cuts of FIGS. 12B, 12C and 12D. The bases (25) are replaceable to adapt to different containers. They have three sensors one in each level that detect the presence of the container to be filled.

FIG. 13 is a perspective view of another optional base (26) with its respective planar views 13A, 13B and 13C to articulate in the window (7a) of FIG. 12 to allow other types of containers.

FIG. 14 is a perspective of the main tank (4a); its design allows it to efficiently take advantage of the internal spaces available within the main structure (1a) of FIG. 7, being able to adapt the size according to the market demand. An optional cover (4c) of the main tank (4a) is illustrated in FIGS. 14A, 14B, 14C, 14D, 14E, 14F seen in different planes and in section to illustrate in detail the main tank (4a) and its optional cover (4c); FIG. 9G is an overflow tank (4b); which is used to store spilled concentrated liquid detergent; it is placed on a platform that has proximity sensors, which by weight allow to determine the level of filling of the tank. In the lower part, the tank has a connection that allows feeding the peristaltic pump (64) by means of a hose, guaranteeing a constant flow of power to it, this by means of a connection through a safety stopcock.

The machine dispenser of fluids has a recess molded on the tank lid composed of two halves, and on one of the two halves is placed a removable collection tray for the collection and cleaning of possible spills.

Through the use of an ultrasonic level sensor, placed on one of the tank tops, monitored by the mother board (59) of the machine, the product inventory is registered in the tank, the control panel governs all the components and processes that make it up; to obtain the defined quantity of product to be dispatched and then to be dispensed to the selected reusable container. The machine has a local and remote communication device and management software, achieving connectivity via the Internet (wi-fi) or through a telephone line (sim card) that reports the status of its components, tank inventory level of product and dispatches made in real time.

FIG. 15 is a block diagram of the control system containing all the parts and electronic parts that control all the processes of the machine. The control system is made up of:
UPS (30): used to power the machine at the time of a power cut.
Power supply source (29): Its function is to feed the control card (5a).
Single Phase Electric Counter (32): Detects power cuts and sends signal to the control card (5a) in order to complete the filling cycle started and/or block the system until the power returns.
Electro fans (44): Used to guarantee the temperature of the following parts: A power source (29), Control card (5a) and communication, Relays card (42) and Motor (15).
WIFI Control Card (31): Responsible for managing all the functions of the machine and establishing a local wireless communication through the TCP/IP protocol.
GSM card (33): Establish remote connectivity with the control center via SMS.
Relay Cards (42): Used to control the signals of Outputs sent by the control card to the following components: Motor (15), valves (43) and electric motor fan (14).
Container sensors (34): determines that the container placed corresponds to the shapes and sizes that the machine allows.
Filling control sensor (35): Used to define a starting point in the filling process of the container.
Spill control sensor (36): Used for spill control during the filling process of the container.
Discharge volume control sensor (37): Controls the amount of liquid detergent requested by the user.
Inventory level sensor (38): Used to control the level of the Main Tank Inventory (4a).
Overflow level sensor (39): It has two functions, the first to control the filling level of the tank avoiding the spill of the liquid and the second to turn off the machine at the moment of a spill.
Touch screen (40): informs the user of the steps to follow to execute the purchase of the liquid detergent and allows operating the program in the interface.
Scanner (41): Bar code reader system used to activate the filling process of the container.

FIG. 16 is a block diagram illustrating the interconnection between the different components to control the static mixer system.

FIG. 17 is a block diagram illustrating the interconnection between the different components to control the dynamic mixer system.

FIG. 18 is the main control card (5a): Arduino Yun is a stand-alone, programmable electronic card, based on the ATmega32u4 microcontroller and the Atheros AR9331 microcontroller. The Atheros processor supports a Linux distribution based on OpenWrt called OpenWrt-Yun. The YUN card has built-in Ethernet and WiFi connections, USB-A port, micro-SD card port, for storage of large volumes of information, 20 digital input/output ports, of which the pin 7 can be used for outputs PWM type and 12 analog inputs of 0-5 VDC. The programming of the YUN card is done in the programming language C, in a development environment provided by the same manufacturer of the card that has been selected in a standard for the development of process control applications.

FIG. 18A is a communication card, Arduino GSM Card, which allows an ARDUINO YUN card (Main Control Board) to connect to the telephone network and through this to the internet, make and receive voice calls (requires a headset and microphone not included with the card) and send and receive SMS text messages. The ARDUINO-GSM card uses a radio frequency M10 modem made by Quectel. Digital pins 2 and 3 are used for serial communication with the M10 modem. Pin 2 connects to the TX pin of the M10 modem and pin 3 to the RX pin of the modem. The M10 modem is Quad-band GSM/GPRS that works on the GSM850 MHz, GSM900 MHz, DCS1800 MHz and PCS1900 MHz frequencies. Supports TCP/UDP and HTTP protocols through the GPRS connection. To connect to the cellular network, a SIM card is required and must be purchased through a mobile operator. FIG. 18B is a relay card; This card has 8 relays with a 12 VDC coil and a capacity to support loads of up to 10 amps. It is used, in conjunction with the programmable card ARDUINO YUN (Main Control Board), to activate/deactivate control elements, such as valves, motors, etc. Each relay is an independent output that can be used at any time by the control program, resident on the ARDUINO YUN Card (Main Control Board), to take action on the control elements of the process in operation. FIG. 18C, is a “Switching” power source, 12 VDC and 10 amps capacity. The power source is used to electrically power the control cards. FIG. 18D, is a barcode reader that captures virtually all 1D and 2D barcodes designed to be installed in a fixed position, has a 624 Mhz processor, RS232, USB and RS485 interface. FIG. 18E is the text screen; LCD screen with 4 lines of text, with a capacity of 20 characters per line. It is connected to the control card ARDUINO YUN (Main Control Board) through the I2C communications protocol. It has backlighting and is powered by 5 VDC which are supplied by the main control card. The program that runs on the control card uses this monitor to inform the user of the status of the purchase process and possible errors that may occur.

As a preferred embodiment of the invention, the container-shaped housing (54) of the machine for mixing and dispensing liquid detergent has a height: 2.40 m [7′-10, 49″ (ft-in)], width: 1.40 m [4′-7, 12″ (ft-in)], depth: 0.90 m [2′-11, 43″ (ft-in)], Area (s/door): 2.83 m², tank capacity: 520 L, estimated weight of the equipment without product: 180 kg (396.83 lb), alternating current input: 110-120 V, frequency between 50-60 Hz, maximum consumption: 2 A., electronic system with a 12 Vdc source −10 A and TTL control system and relay system and light and motor control driver. The machine to mix and dispense liquid detergent has a communication system to establish connection with external peripherals, using any existing protocol; linear bar code reader scanner, the touch screen (40) of the equipment provides information in real time (HMI).

Inside the inspection hatch of hydraulic system (53) in the lower part, the machine has a pump designed for the efficient dispensing of the product, tank and auxiliaries designed and manufactured to guarantee the stability of the product, filling spout designed to adapt to any bottle neck diameter that enters the container holder, maintaining laminar flow with anti drip mechanism.

FIG. 19 shows a top view of the dispensing frame (56) with the screen (40) and the scale (55) shown in detail in FIG. 20 and that is responsible for calculating the weight of the material dispensed in the filling container.

Inside the dispensing frame (56) preformed of polyester reinforced with glass fiber is the packaging carrier (69) made of stainless steel, designed to control by weight the volume of product to be dispensed by means of a scale (55) screwed to a flange (70), welded to a support tray (71) and connected to a cylinder (72) spacer to the weighing tray, the design provides for the timely drainage of possible product spills.

The automation software executes the device components shown in FIG. 21. It must be taken into account that for the installation of the machine to mix and dispense liquid detergent the area for the installation of the equipment must have 2 m wide, 1.5 m of depth and 2.5 m of height; the equipment must be connected to a stable alternating current source (57) between 110-120 V, 50-60 Hz with a maximum consumption of 2 A and verify the grounding and must be placed, avoiding exposure to sunlight and maintaining a distance of 3 meters from other electronic equipment. The alternating current (57) passes through an AC-DC converter (58) from alternating current to direct current when the screen is manually executed (40).

As a way of executing the invention, according to that with FIG. 21, assembling in a mother card (59) the level sensor (60) of inventory, scanner (61), bottle presence sensor (62), cells charge (63), peristaltic pump (64) with its cell counts pulses (65). The connection where the products to be dispensed flow is carried out with hoses resistant to the products to be dispensed; where said products move from the dispensing tank to the safety key, then from the safety key to the peristaltic pump (64) which is controlled by the automation software and continues from the peristaltic pump (64) to the filling peak.

The motherboard (59) is a programmable autonomous electronic card that can be Arduino type programmed with programming language C, in a development environment provided by the same manufacturer of the card that has been selected in a standard for the development of applications of process control. The mother card (59) has a relay card (66) connected; This relay card has 8 relays with coil (67) of 12 VDC and with capacity to support loads up to 10 amps. The relay card (66) is used in conjunction with the motherboard (59) to activate and deactivate control elements, such as valves, motors or sensors. Each relay is an independent output that can be used at any time by the control program resident on the motherboard (59) to take action on the control elements of the process in operation.

Particularly, the fluid dispensing machine has a dispenser provided with a control panel which is contained in a protective vault with all the electronic parts and parts that govern all the processes of the machine and a housing containing: a power source (57) whose function is to feed the mother card (59) and its computer; Two Electro Fans (73) used to guarantee the temperature of the following parts: power source (57), motherboard (59) and its control and communication card (74), relay card (66) and connection terminal; where the Relay Card (66) is used to control the output signals sent by the control card to the following components: Peristaltic pump (64), Container sensor (62) that validates the presence of container on the scale (55); Load Cells (63) which is the control instrument for the dispensing volume dispensed; Level sensor (60) used to control the level of the Main Tank; touch screen (40) with computer that informs the user the steps to follow to execute the purchase of the product and Bar Code Reader (41) used to activate the filling process of the container.

The power source (57) is 12 Volts DC and 10 amps capacity. The power source (57) is used to electrically energize the control cards.

As the machine's execution inputs, there is the Bar Code reader (41) that is fixed and captures virtually a wide range of codes. It also has as an input peripheral the screen (40) that allows the interaction with the mother card (59) of the equipment, connected by the I2C communications protocol and energized by the power source (57). The automation software runs on the motherboard (59) and uses the screen (40) to inform the user of the sequence of the purchase process and displays notifications of initiation and completion of the processes to the user.

FIG. 22: It shows a diagram of interconnection and operation of the device with the operation of a management software on an internet connection platform and a server by the owner and technical support personnel for executing a set of touch screens (40) simultaneously under connection via internet with a technical terminal (76), a franchised operative terminal (77), a second franchised operative terminal (78) and the interaction with a central server (79).

According to the dispensing software of FIG. 2 and the operating process that is executed from the touch screen (40) the following steps must be followed:
Connect the equipment to the AC power supply (57)
Turn the ignition switch to the “ON” position.
The permanent illumination led indicator will light up.
Touch the touch screen (40).
The touch screen (40) will request an access code.
The “Data Record” screen appears in white.
The touch screen (40) has two options to move between screens, they are two arrows located at the bottom.
When you touch the arrow with the word “Next”, you will be presented with the calibration screen, the procedure is at the bottom left of the screen.
The touch screen (40) has two options for moving between screens, two arrows located at the bottom.
When you touch the arrow with the word “Next”, you will be presented with the “Current Tank Content (L)” screen, the procedure is at the bottom of the screen.
By touching the arrow with the word “Next”, you will be presented with the “Diagnostic Screen”, in which the technical service personnel can verify the correct operation of the equipment.
Touching the “CLIC” logo located in the upper left part of the screen returns to the main screen, and finishes the process of set-up of the equipment.
Next, the dispensing software is activated and the user must place the container in the container and insert the filling spout into the neck of the container, in the touch screen (40) the following message will appear: “Place the Bottle . . . !!”, the led indicator of container presence will light up and the scanner laser of the bar code reader will activate.
The touch screen (40) will show the message “Present the Ticket . . . !!”, proceed to present the barcode on the reader.
Start dispensing the product to the container. The touch screen (40) will show the following message: “Dispatching, please wait . . . !!”
At the end of the dispensing of the product, the touch screen (40) will show the following message: “Remove the bottle, please . . . !!””
Remove the bottle with the detergent product mixture from the equipment and place the lid.

Described as it has been the present invention in its most relevant characteristics is declared the property and originality of the following claims:

1- An automatic liquid detergent dispensing machine remotely controlled by a control software connected to a server that updates the databases of liquid and detergent content, weight of the mixture and calibration of quantity of product to be delivered, also executed with another dispensing software characterized by a control panel of injectors, solenoid valves and mixers that is contained in a protective vault with all the parts and electronic parts that govern all the processes of the machine and a housing with one or more tanks that contains: Power source (57) whose function is to feed the mother card (59) and its computer; Two Electro Fans (73) used to guarantee the temperature of the following parts: power source (57), motherboard (59) and its control and communication card (74), relay card (66) and connection terminal; where the Relay Card (66) is used to control the output signals sent by the control card to the following components: Peristaltic pump (64), Bottle presence sensor (62) that validates the presence of container on the scale (55); Load Cells (63) which is the control instrument for the dispensing volume dispensed; Level sensor (60) used to control the level of the Main Tank; touch screen (40) with computer that informs the user the steps to follow to execute the purchase of the product and Bar Code Reader (41) used to activate the filling process of the container.

2- An automatic liquid detergent dispensing machine remotely controlled by a control software connected to a server according to claim 1, characterized in that the mother card (59) is a programmable autonomous electronic card that can be Arduino type programmed with programming language C, in a development environment provided by the same manufacturer of the card that has been selected in a standard for the development of process control applications; where the mother card (59) has a relay card (66) and has 8 relays with coil (67) of 12 VDC and with capacity to support charges up to 10 amps, said relay card (66) used together with the mother card (59) to Activate and Deactivate control elements, such as valves, motors or sensors and where each relay is an independent output that can be used at any time by the control program resident on the motherboard (59) to take action on the control elements of the process in operation.

3- An automatic liquid detergent dispensing machine remotely controlled by a control software connected to a server according to claim 1, characterized in that it drives two injectors (3a) and (3b) by means of a displacement shaft (21) longitudinal suction of the filtered water and suction of concentrated liquid from an overflow tank (4a); whose control software executes two connected solenoid valves (22) and (23) that take liquid from an upper cylinder (20) and send it to a static mixer (2a) or to a dynamic mixer (2b) and conducts the mixed liquid to a tank of finished product (16) to be dispensed, when the dispensing software is executed by a filling spout (45) located in the upper part of the container detector (34); where the detergents of the machine are surfactant detergents with tensio-active anionic and cationic chemical compounds as base of their formulation selected from Genapol, sodium phenyl sulfonate and sodium lauryl sulfonate; preservatives such as formaldehyde and bactericides such as glutaraldehyde, with a concentrated detergent mixture to be mixed with water in a proportion between 30% and 40%; also characterized in that the liquid detergent dispensing machine has a container-shaped housing (54) with a touch screen (40) with an execution interface of a dispensing software; scanner (41) that verifies the reading of a barcode associated with the amount of detergent mixture to be dispensed; a filling spout (45) located at the top of the container detector (34); a spill grid (46) with a scale (55) located at the bottom of a window (7).

4- An Automatic machine for mixing and dispensing of liquid detergents remotely controlled according to claim 1, characterized in that the container-shaped housing (54) has a reinforced base (47) with transport guides (48) and legs (51) and because inside the window (7) that receives containers there is the led indicator of presence of a container (49) and a permanent led light (50) to visualize the dispensation and inside the housing there is a tank that in a lower part has a connection that allows feeding the peristaltic pump (64) by means of a hose, guaranteeing a constant flow of power to it, this by means of a connection for a safety stopcock; and the lid of the tank has two halves and on one of the two halves is placed a removable collection tray for the collection and cleaning of possible spills.

5- Automatic machine for mixing and dispensing liquid detergents remotely controlled according to claim 1, characterized in that the container-shaped housing (54) is made of molded pieces of glass fiber reinforced polyester (prefabricated monoblock shells) and has a frame (56) preformed fiberglass reinforced polyester having a carrier (69) made of stainless steel, designed to control by weight the volume of product to be dispensed by means of a scale (55) screwed to a flange (70), welded to a support tray (71) and connected to a cylinder (72) spacer to the weighing tray, the design provides for the timely drainage of possible product spills; where the dispensing frame (56) has a filling peak with vertical displacement to adapt to the different sizes of containers and said filling peak is made of stainless steel and has an anti-drip mechanism.

6- An Automatic machine for mixing and dispensing liquid detergents remotely controlled according to claim 1, characterized in that the control software has a control mechanism with all parts and electronic parts in an electronic card (5a) inside the structure (1a) that govern all the processes of the equipment conformed by a WIFI Control Card (31) responsible for managing all the functions of the machine and establishing a local wireless communication through the TCP/IP protocol that reports the status of its components, level of filling of the product tank, overflow tank and transactions; where the state of components is carried out with sensors located in the central window (7a) which are: Container Sensor (34) where the bottle to be filled is placed; a filling control sensor (35) that initiates the filling of the bottle and spill control sensor (36) of the filling of the bottle; and internal sensors in each tank: a discharge volume control sensor (37) and a level sensor (38) located in the main tank (4a) that controls the level; as well as a Overflow level sensor (39) located in the overflow tank (4b) that has two functions, the first, controlling the filling level of the filling tank avoiding the spill of the liquid and the second turning off the machine at the time of producing a leak; complemented with a Relay Card (42) in the center of the structure (1a) that controls the output signals sent by the electronic card (5a) to the motors (13), (15), (43), solenoid valves (22), (23) and Electro Fans (31); an external power source (30) connected to a single-phase electric contactor (32) located inside structure (1a) that sends signal to the electronic card (5a) in order to block or start the system until the power returns; A Bar Code Reader (41) to activate the process of filling the bottle and a Text Screen (40) that informs the user of the steps to follow to execute the mixture of liquid and viscous chemical products.

7- An Automatic machine for mixing and dispensing liquid detergents remotely controlled according to claim 1, CHARACTERIZED because the static mixer (2a) has an injector (3a) that sucks filtered water from a tank (11), in parallel has a second injector (3b) that sucks the concentrate liquid from the main tank (4a), where both injectors (3a) and (3b) feed the static mixer (2a) with a homogeneous mixture that is deposited in a tank of finished product (16) that by suction it is deposited in the container; and where the dynamic mixer (2b) has a diaphragm pump (17) that sucks filtered water from a tank (11), in parallel it has a second diaphragm pump (18) that sucks the concentrated liquid from the main tank (4a) and where both pumps feed the dynamic mixer (2b) with an agitator screw (19) with a homogeneous mixture that is deposited in a tank of finished product (16) that is dispensed in the container by suction.

8- An Automatic machine for mixing and dispensing liquid detergents remotely controlled according to claim 1, characterized in that the container-shaped housing (54) has a height: 2.40 m [7′-10, 49″ (ft-in)], width: 1.40 m [4′-7, 12″ (ft-in)], depth: 0.90 m [2′-11, 43″ (ft-in)], Area (s/door): 2.83 m², capacity of the tank: 520 L, estimated weight of the equipment without product: 180 kg (396.83 lb), alternating current input: 110-120 V, frequency between 50-60 Hz., maximum consumption: 2 A., electronic system with a source of 12 Vdc-10 A and TTL control system and a relay system and light and motor control driver; with a communication system to establish connection with external peripherals, using any existing protocol; linear barcode reader scanner and its touch screen (40) of the equipment provides real-time information (HMI) with communication programming of its motherboard (59) through the I2C communications protocol.

9- An Automatic machine for mixing and dispensing liquid detergents remotely controlled according to claim 1, characterized in that it is executed by interconnection and operation of the device with the operation of a management software on an internet connection platform and a server by the owner and technical support personnel for executing a set of touch screens (40) simultaneously under internet connection with a technical terminal (76), a franchised operating terminal (77), a second franchised operating terminal (78) and interaction with a central server (79).

10- An Automatic machine for mixing and dispensing liquid detergents remotely controlled according to claim 1, characterized in that the execution process is complemented with dispensing software and executed from the touch screen (40) with the following steps:
Connect the equipment to the AC power supply (57)
Turn the ignition switch to the “ON” position.
The permanent illumination led indicator will light up.
Touch the touch screen (40).
The touch screen (40) will request an access code.
The “Data Record” screen appears in white.
The touch screen (40) has two options to move between screens, they are two arrows located at the bottom.
When you touch the arrow with the word “Next”, you will be presented with the calibration screen, the procedure is at the bottom left of the screen.
The touch screen (40) has two options for moving between screens, two arrows located at the bottom.
When you touch the arrow with the word “Next”, you will be presented with the “Current Tank Content (L)” screen, the procedure is at the bottom of the screen.
By touching the arrow with the word “Next”, you will be presented with the “Diagnostic Screen”, in which the technical service personnel can verify the correct operation of the equipment.
Touching the “CLIC” logo located in the upper left part of the screen returns to the main screen, and finishes the process of set-up of the equipment.
Next, the dispensing software is activated and the user must place the container in the container and insert the filling spout into the neck of the container, in the touch screen (40) the following message will appear: “Place the Bottle . . . !!”, the led indicator of container presence will light up and the scanner laser of the bar code reader will activate.
The touch screen (40) will show the message “Present the Ticket . . . !!”, proceed to present the barcode on the reader.
Start dispensing the product to the container. The touch screen (40) will show the following message: “Dispatching, please wait . . . !!”
At the end of the dispensing of the product, the touch screen (40) will show the following message: “Remove the bottle, please . . . !!””
Remove the bottle with the detergent product mixture from the equipment and place the lid.
